(19) United States
(12) Patent Application Publication
(10) Pub. No.: US 2006/0036669 A1
(43) Pub. Date: Feb. 16, 2006

(54) Integrated circuit and method for establishing transactions

(75) Inventor: Andrei Radulescu, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: koninklijke Philips Electronics N.C.

(21) Appl. No.: 10/530,298

(22) PCT Filed: Oct. 7, 2003
(86) PCT No.: PCT/IB03/04401

§ 371 Date: Apr. 5, 2005

(30) Foreign Application Priority Data
Oct. 8, 2002 (EP) 02079196.8
Apr. 22, 2003 (EP) 03101095.2

(51) Int. Cl. G06F 15/16

(52) U.S. Cl. 709/200

(57) ABSTRACT

An integrated circuit (IC) comprises a network and a plurality of modules (M1, M2, M3) which communicate to each other via the network. A first module (M1) sends a plurality of requests (REQ) to at least two second modules (M2, M3, Mn) and the second modules send individual responses (RESP2, RESP3, RESPn) to the first module, indicating a result of the execution of the requests. The integrated circuit (IC) comprises a network capable of sending a single response (SRESP) to the first module (M1) dependent on the individual responses (RESP2, RESP3 up to and including RESPn) from the second modules (M2, M3, Mn). The single response (SRESP) can indicate that at least one second module has executed the requests (REQ) or that a specific error has occurred in at least one of the second modules (M2, M3, Mn). The single response (SRESP) can also indicate which types of error have occurred in the second modules (M2, M3, Mn). If various errors have occurred, the single response (SRESP) can indicate which error is the most serious error or information about all errors.

The invention relates to an integrated circuit comprising a network and a plurality of modules, which are arranged to communicate to each other via the network, wherein the network is arranged to establish transactions between a first module and at least two second modules, the network being arranged to send a plurality of requests from the first module to the second modules, and wherein the second modules are arranged to generate individual responses indicating a result of the execution of the requests.

The invention also relates to a method for establishing transactions in an integrated circuit comprising a network and a plurality of modules, the transactions between the modules being established via the network, wherein the network sends a plurality of requests from a first module to at least two second modules, and wherein the second modules generate individual responses indicating a result of the execution of the requests.

Systems on silicon show a continuous increase in complexity due to the ever-increasing need for implementing new features and improvements of existing functions. This is enabled by the increasing density with which components can be integrated on an integrated circuit. At the same time the clock speed at which circuits are operated tends to increase too. The higher clock speed in combination with the increased density of components has reduced the area which can operate synchronously within the same clock domain. This has created the need for a modular approach. According to such an approach the processing system comprises a plurality of relatively independent, complex modules. In conventional processing systems the modules usually communicate to each other via a bus. As the number of modules increases however, this way of communication is no longer practical for the following reasons. First, the large number of modules forms a too high bus load. Second, the bus forms a communication bottleneck as it enables only one device to send data to the bus.

A communication network forms an effective way to overcome these disadvantages. The communication network comprises a plurality of partly connected nodes. Requests from a module are redirected by the nodes to one or more other nodes. To that end the request comprises first information indicative for the location of the addressed module(s) within the network. The request may further include second information indicative for a particular location within the module, such as a memory, or a register address. The second information may invoke a particular response of the addressed module.

A transaction model can be used in a network on an integrated circuit to establish communication between the modules. A basic transaction comprises a request and a response which indicates the result of the execution of the request. In a multicast transaction, the request from a first module is replicated and each addressed module receives a copy of the request, so that the first module sends a plurality of requests to at least two second modules. Subsequently, the second modules send individual responses to the first module.

The concept of multicasting has been applied in areas different from networks on integrated circuits, but its implementation is rather limited until now in the sense that it only covers the acknowledgment of the receipt of a plurality of write messages instead of the acknowledgment of the execution of a plurality of requests. A request may comprise a write command and a data part or it may comprise a read command. According to the state of the art, it is possible to send a plurality of write messages from a first module to two or more second modules. This is a multicast write message; the second modules can send acknowledge messages to the first module which indicate whether the write messages have been received. However, this method of multicasting is limited because the acknowledgments do not indicate whether the write messages have been executed by the second modules.

Such a method of multicasting is disclosed in U.S. Pat. No. 5,541,927. The method limits the number of return messages from a plurality of destination nodes to a source node, which is accomplished using intermediate nodes in the network. The intermediate nodes are the only nodes in the entire network that are authorized to send return messages to the source node. Underlying nodes send their return messages to the intermediate nodes, but not to the source node. This method reduces the number of return messages to the source node and it elaborates on merging acknowledge messages which merely indicate the receipt of a message.

A shortcoming of the multicast transaction is that the individual responses from the second modules (also referred to as slaves, slave modules or destinations) impose a large burden on the first module (also referred to as master, master module or initiator). Consequently, the complexity of the first module increases because all individual responses from the second modules must be processed by the first module. Furthermore, the first module is less reusable as a network component because it depends on the number of second modules. This makes the network architecture incompatible with the bus architecture, since the first module does not depend on the number of second modules when the bus architecture is used.

It is an object of the invention to provide an integrated circuit and a method of the kind set forth which reduce the burden on the first module. In order to achieve the said object the integrated circuit is characterized by the characterizing portion of claim 1 and the method is characterized by the characterizing portion of claim 9.

In a processing system with modules working asynchronously with respect to each other a second module typically sends an individual response to inform the first module that it has executed the request of the first module. If a request is multicast a plurality of said individual responses is generated, which imposes a large burden on the first module. In the integrated circuit of the invention the first module receives only a single response, which reduces this burden.

A dedicated node in the network may be used for generating and sending the single response. The embodiment defined in claim 2 comprises a network interface to generate and send the single response.

The embodiment defined in claim 3 is favorable if the value of the single response depends on the values of the individual responses from the second modules. This results in a combined response, representing the output of a specific function of the individual responses from the second modules. The specific function returns the value of the single response, which is based on the values of the individual responses.

Depending on circumstances, the single response can be based on the individual responses in various ways. The embodiment defined in claim 4 is favorable where the addressed second modules are duplicated memories, for example memories in a fault-tolerant memory system, and the first module attempts to store data therein. In that case it is sufficient that only one copy of the data is received and stored. The specific function indicates a success by returning a value representing a success. In this embodiment, the specific function returns a success if at least one value of the individual responses represents a success.

In other situations it is compulsory that each of the addressed second modules executes the request, for example if the addressed second modules are memories in a distributed memory system. In the embodiment defined in claim 5 the single response is not generated until this is the case. The single response is generated only if all individual responses have a value representing success.

The embodiment defined in claim 6 represents a particular case, wherein the specific function returns a value representing success if no error occurred and if at least one error occurred a value representing the most serious error.

The embodiment defined in claim 7 represents another particular case, wherein the values of the individual responses of the second modules are specified according to the type of error that occurred. This embodiment is favorable when it is necessary to determine the cause of the error that occurred; this cause is then communicated to the first module. If several errors occur, alternative values for the single response can be generated. It is possible to choose the value of the most serious error that occurred for the value of the single response, or the single response may be a combined response containing all the values of the individual responses, providing complete information about the errors that occurred.

The embodiment defined in claim 8 can be used to perform a compound command like the test-and-set command by means of subsequent multicast transactions. In that case, the single response of the first multicast transaction carries data parts of the second modules and indicates which data parts belong to which second modules. This information is needed by the first module to perform a conditional test and to send another plurality of requests, so that new data are written to those second modules that passed the conditional test.

The invention overcomes the shortcomings of multicast transactions in networks on an integrated circuit, because the amount of responses to the first module is reduced from many to one.

It is noted that a method of multicasting is disclosed in WO 02/23814. The method merges acknowledge messages in networked environments other than networks on integrated circuits using switches as connecting nodes. The method assumes that return messages arrive simultaneously, thus limiting the use of merged acknowledgements to a particular situation.

The present invention is described in more detail with reference to the drawings, in which:

FIG. 1 illustrates a network on an integrated circuit;

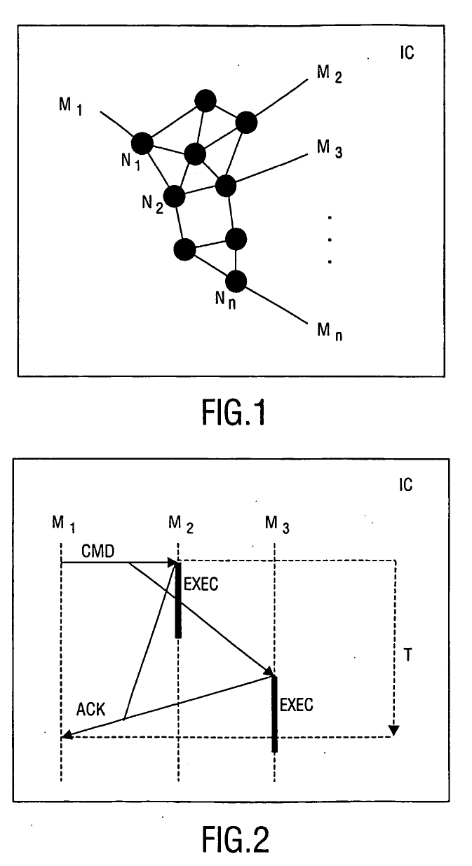

FIG. 2 illustrates a concept of multicast messages;

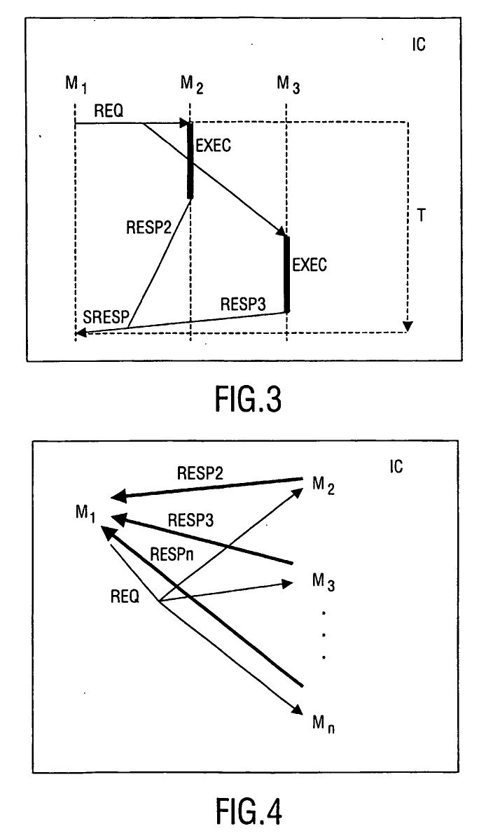

FIG. 3 illustrates a concept of multicast transactions according to the invention;

FIG. 4 illustrates a multicast transaction in a network on an integrated circuit;

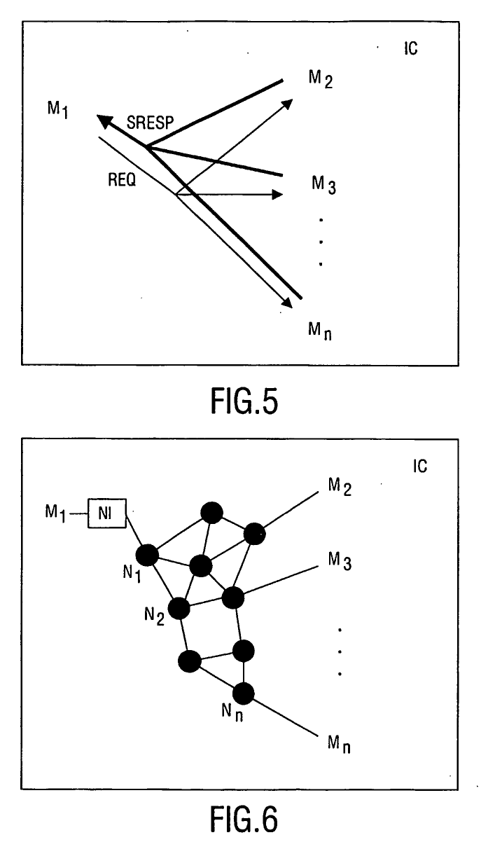

FIG. 5 illustrates a multicast transaction according to the invention;

FIG. 6 illustrates a network on an integrated circuit which deploys a network interface;

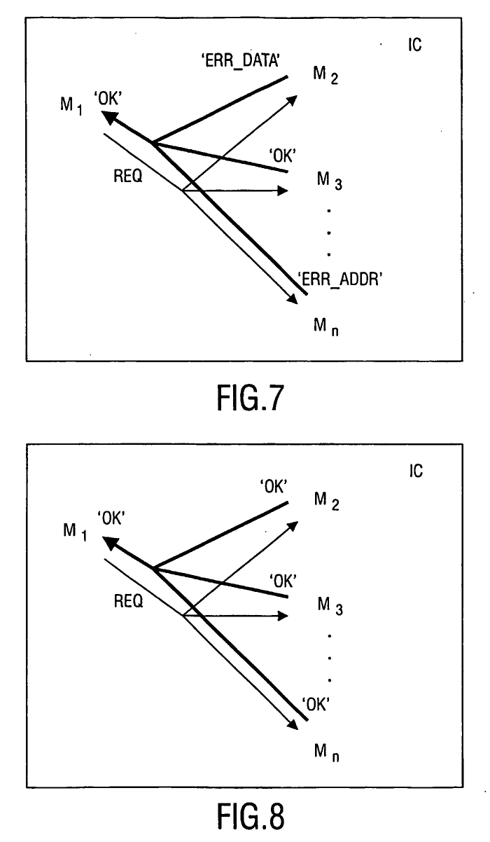

FIG. 7 illustrates a multicast transaction with a single response, wherein at least one second module must receive the requests issued by the first module;

FIG. 8 illustrates a multicast transaction with a single response, wherein all second modules must receive the requests issued by the first module;

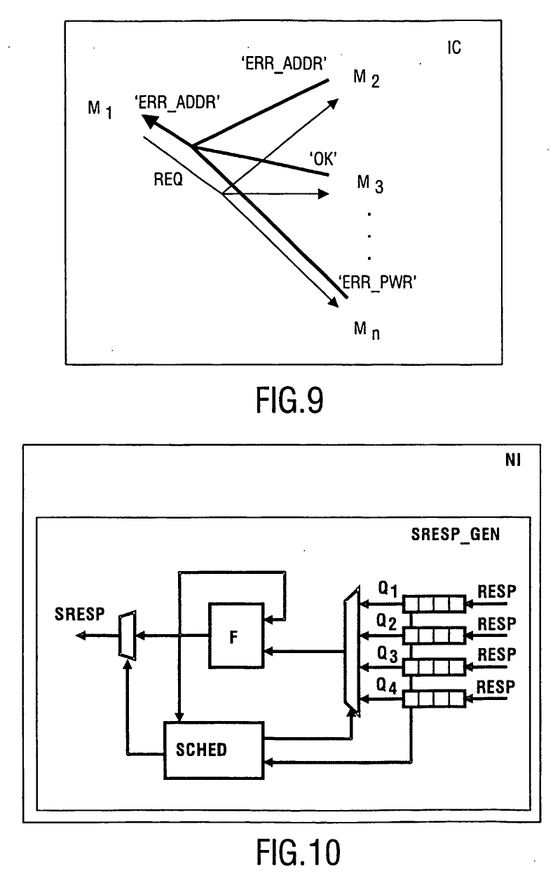

FIG. 9 illustrates a multicast transaction with a single response, wherein the value of the response indicates the most serious error that occurred.

FIG. 10 illustrates a possible implementation of the network functionality according to the invention;

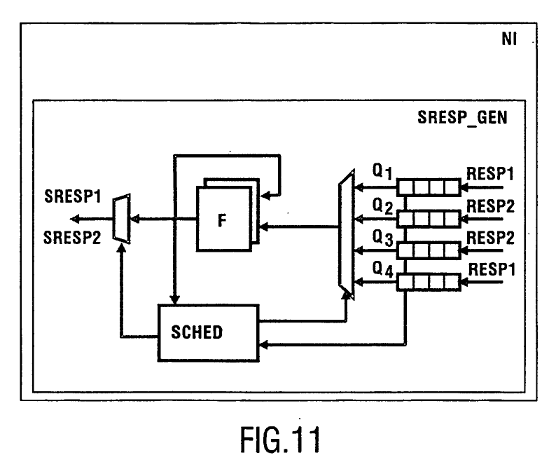

FIG. 11 illustrates an alternative implementation of the network functionality according to the invention.

FIG. 1 schematically shows an integrated circuit IC which deploys a network for communication between a plurality of modules M₁, M₂, M₃ up to and including Mₙ. Examples of modules are central processing units (CPUs), application specific processors, memories and memory controllers. The network comprises nodes N₁, N₂ up to and including Nₙ, and connections between the nodes. This network architecture provides the interconnect between the modules and can be deployed as an alternative for the conventional bus architecture on an integrated circuit.

FIG. 2 illustrates a concept of multicast messages. A first module M₁ sends a replicated write message MSG to at least two second modules M₂, M₃ or alternatively the write message MSG is replicated by the network. The acknowledgements of the second modules M₂, M₃ merely indicate the receipt of the messages MSG; they are combined into a single acknowledgement ACK which is sent to the first module M₁ after a certain amount of time T. In this manner the result of the execution EXEC of the messages MSG is not taken into account. This concept of multicast messages is known from the state of the art and is applicable in networks on an integrated circuit.

FIG. 3 illustrates a concept of multicast transactions according to the invention. A first module M₁ sends a replicated request REQ to at least two second modules M₂, M₃. The individual responses RESP2, RESP3 of the second modules M₂, M₃ indicate the result of the execution EXEC of the requests; they are combined into a single response SRESP which is sent to the first module M₁ after a certain amount of time T.

FIG. 4 illustrates a multicast transaction which imposes a large burden on the first module M₁. The transaction comprises a replicated request leading to a plurality of requests REQ and a plurality of individual responses RESP2, RESP3 up to and including RESPn. The integrated circuit IC as illustrated in FIG. 1 comprises a plurality of modules M₁, M₂, M₃ up to and including Mₙ, connected by a network. A first module M₁, also referred to as master, master module or as initiator, is configured to send the requests REQ to second modules M₂, M₃ up to and including Mₙ, also referred to as slaves, slave modules or as destinations. The second modules are configured to send the individual responses RESP2, RESP3 up to and including RESPn to the first module.

A multicast transaction according to the invention is illustrated in FIG. 5. The transaction comprises a replicated request leading to a plurality of requests REQ and a single response SRESP. The integrated circuit IC again comprises a plurality of modules M₁, M₂, M₃ up to and including Mₙ, connected by a network. Through this network a single response SRESP, based on the individual responses from the second modules M₂, M₃ up to and including Mₙ, can be sent to the first module M₁. The network is configured to send a single response SRESP to the first module M₁ which indicates the result of the execution of the requests REQ.

For this purpose the network can deploy a network interface which is coupled to the first module M₁. The network interface NI is then a component of the network which is coupled to the first module M₁ and to at least one of the nodes N₁, N₂ up to and including Nₙ, as illustrated in FIG. 6. The network interface NI is able to combine the individual responses RESP2, RESP3 up to and including RESPn from the second modules M₂, M₃ up to and including Mₙ and generate a single response SRESP to the first module M₁. Since the network interface NI is arranged to perform this task instead of the first module M₁, the burden on the first module is reduced significantly. Alternatively, a dedicated node in the network can perform this task depending on the configuration of the network. Since in this manner the first module M₁ is made independent from the number of second modules M₂, M₃ up to and including Mₙ, the reusability of the first module as a network component improves significantly.

A request comprises a basic command, for example a read or a write command, and optionally it comprises a data part. A response comprises an acknowledgement and optionally it comprises a data part.

For example, the requests REQ in a multicast transaction carry a read command. The corresponding single response SRESP then carries an acknowledgement, indicating the result of the execution of the read command by at least one of or by all second modules M₂, M₃ up to and including Mₙ, and it also carries the data, which are delivered to the first module M₁. Alternatively, the requests REQ carry a write command and the data, which have to be written to the second modules M₂, M₃ up to and including Mₙ. The corresponding single response SRESP then carries an acknowledgement, but it does not carry a data part.

An example of a more complex command is the test-and-set command, also referred to as a compound command. The test-and-set command writes data to at least one of the second modules M₂, M₃ up to and including Mₙ dependent on a conditional test performed on the second modules. The following multicast transactions are needed to perform this compound command:
a plurality of requests REQ to read the data needed to perform the conditional test, the requests carrying a read command and information which indicates that a flag should be set on the slaves, the flag indicating that other masters than master M₁ should not perform write operations on the slaves; the corresponding single response SRESP carrying data parts of the second modules and indicating which data parts belong to which second modules;
a plurality of requests REQ to write new data to those second modules which passed the conditional test, the requests carrying a write command, a data part and information which indicates that the said flag should be unset; the corresponding single response SRESP carrying an acknowledgement of the write operations.
   The single response SRESP carrying data parts of the second modules M₂, M₃ up to and including Mₙ and indicating which data parts belong to which second modules forms part of a read transaction which can be used independently or which can be used as a constituent to perform the said test-and-set command.

Other particular commands (not described) may also use the concept of multicast transactions which is disclosed herein.

As an example of the return values for a request comprising a read or a write command, the individual responses from the slaves RESP2, RESP3 up to and including RESPn can have the following values and their respective meanings:
‘OK’: the command has been completed successfully,
‘ERR_DATA’: corrupted data received at or written to slave module;
‘ERRDROPPED’: data dropped by the interconnect due to internal buffer overflow;
‘ERRPWR’: command could not be performed because the slave is in power-saving mode;
‘ERR_SLAVE’: command failed due to internal error of the slave;
‘ERR_ADDR’: command failed because of an invalid address.

The single response SRESP may also have one of the above-mentioned values, dependent on the values of the individual responses RESP2, RESP3 up to and including RESPn from the slaves. For example, if the requests REQ were executed successfully by a subset of the slaves and if the requests REQ resulted in an invalid address error by a different subset of the slaves, then the individual responses RESP2, RESP3 up to and including RESPn of the slaves can have two different values: ‘OK’ and ‘ERR_ADDR’. Alternatively, the individual responses RESP2, RESP3 up to and including RESPn can have other values depending on the type of error that occurred. One of the values can be marked as the value representing the most serious error, for example ‘ERR_ADDR’. The value ‘OK’ is marked as the value representing no error. Depending on circumstances, the single response has the value ‘OK’ or a value representing the most serious error of the individual responses.

Using a compound command like the test-and-set command may require other contents of the single response SRESP. In the example of the test-and-set command, the single response SRESP of the first multicast transaction can carry data parts of the second modules M₂, M₃ up to and including Mₙ and can indicate which data parts belong to which second modules.

In an embodiment of the invention shown in FIG. 7, at least one of the individual responses from the slaves must have the value ‘OK’ before the single response with value ‘OK’ for the master is generated.

In an embodiment of the invention illustrated in FIG. 8, all individual responses from the slaves must have the value ‘OK’ before the single response with value ‘OK’ for the master is generated.

In another embodiment of the invention shown in FIG. 9, the values of the individual responses from the slaves can be combined into a single response with the value ‘ERR_ADDR’ to specify that at least one error occurred and that the most serious error was an invalid address error. The single response has the value ‘ERR_ADDR’ instead of ‘ERR_PWR’ because an error caused by an invalid address is considered more serious than an error caused by the power-saving mode of a slave. Alternatively, another error may be considered more serious than the invalid address error, and therefore the hierarchy of error messages may be different.

In another embodiment (not shown), a single response is generated, which is larger and more descriptive, encoding for which slaves the errors have occurred. In this embodiment all individual responses can be bundled in the single response for the master or <slave identifier, error code> pairs can be bundled to form the single response.

FIG. 10 illustrates a possible implementation of the network functionality according to the invention. A single response generator SRESP_GEN generates a single response SRESP based on a function F of a plurality of individual responses RESP from the second modules. In this case queues Q₁, Q₂, Q₃, Q₄ are associated with four second modules sending individual responses RESP. The single response generator SRESP_GEN is comprised in a network interface NI. Alternatively, the single response generator SRESP_GEN is comprised in a dedicated node within the network. The network may comprise more than one single response generator SRESP_GEN.

The single response generator SRESP_GEN has queues Q₁, Q₂, Q₃, Q₄ in which the individual responses RESP are queued in order. This facilitates ordered data transport and in this manner it is possible to perform reordering of responses before queuing. If several single responses SRESP should be delivered to the first module M₁, then the single responses SRESP must be delivered in order. If individual responses RESP for a subsequent single response SRESP exist in the queues, then the scheduler SCHED is notified. The scheduler SCHED passes on one individual response RESP at a time to a function F. The function F can be a comparison function, for example a function to generate a single response SRESP with a value representing the most serious error that occurred. If all individual responses RESP have been considered or if the result of function F cannot be changed by remaining individual responses RESP, then the result of function F is passed on as the single response SRESP.

An alternative implementation is shown in FIG. 11, in which generating several single responses SRESP can be pipelined. A subsequent single response SRESP2 can start being processed if some its individual responses RESP2 have arrived (for example in queues Q₂ and Q₃), even if the single response SRESP1 has not been processed completely because not all of its individual responses RESP1 have arrived (only those in queues Q₁ and Q₄ have arrived). This example illustrates the principle of pipelining for a pipeline depth of 2; it can be generalized to a variable pipeline depth of N.

It is remarked that the scope of protection of the invention is not restricted to the embodiments described herein. Neither is the scope of protection of the invention restricted by the reference symbols in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

1. Integrated circuit comprising a network and a plurality of modules which are arranged to communicate to each other via the network, wherein the network is arranged to establish transactions between a first module and at least two second modules the network being arranged to send a plurality of requests from the first module to the second modules, and wherein the second modules are arranged to generate individual responses indicating a result of the execution of the requests, characterized in that the network is arranged to generate a single response to the first module, dependent on the individual responses of the second modules.

2. Integrated circuit according to claim 1, wherein the network comprises a network interface (NI) to generate the single response to the first module.

3. Integrated circuit according to claim 1, wherein the single response has a value which is dependent on a specific function of the individual responses of the second modules.

4. Integrated circuit according to claim 3, wherein the specific function is defined such that the value of the single response indicates that at least one of the second modules has successfully executed the requests issued by the first module.

5. Integrated circuit according to claim 3, wherein the specific function is defined such that the value of the single response indicates that each of the second modules has successfully executed the requests issued by the first module.

6. Integrated circuit according to claim 3, wherein the specific function is defined such that the value of the single response indicates a success if no error occurred and the value of the single response indicates a failure if at least one error occurred, wherein the value of the single response represents the most serious error.

7. Integrated circuit according to claim 3, wherein the specific function is defined such that the value of the single response indicates which types of error have occurred during execution of the requests.

8. Integrated circuit according to claim 1, wherein the individual responses carry data parts transmitted by the second modules, the single response comprising the data parts and indicating which data parts originate from which second modules.

9. Method for establishing transactions in an integrated circuit (IC) comprising a network and a plurality of modules, the transactions between the modules being established via the network, wherein the network sends a plurality of requests from a first module to at least two second modules, and wherein the second modules generate individual responses indicating a result of the execution of the requests, characterized in that the network generates a single response (SRESP) to the first module, dependent on the individual responses of the second modules.
